(19) United States
(12) Patent Application Publication
(10) Pub. No.: US 2003/0108585 A1
(43) Pub. Date: Jun. 12, 2003

(54) Polymer conjugates of insecticidal peptides or nucleic acids or insecticides and methods of use thereof

(76) Inventors: R. Michael Roe, Middlesex, NC (US); Alan E. Brandt, Chapel Hill, NC (US)

Correspondence Address: MYERS BIGEL SIBLEY & SAJOVEC, PO BOX 37428, RALEIGH, NC, 27627, US

(21) Appl. No.: 10/285,398

(22) Filed: Oct. 31, 2002

Related U.S. Application Data
(63) Continuation-in-part of application No. 10/139,105, filed on May 3, 2002.
(60) Provisional application No. 60/288,714, filed on May 4, 2001.

(51) Int. Cl. A01N 43/04; A01N 25/00

(52) U.S. Cl. 424/405; 514/12; 424/94.6; 514/44

(57) ABSTRACT

Insecticidal compounds comprising an insecticidal peptide (e.g., juvenile hormone esters) or nucleic acid (e.g. Ea baculovirus) or insecticide covalently conjugated to a polymer are described. Methods of use thereof for controlling insects and compositions containing the same are also described.

### CROSS REFERENCE TO RELATED APPLICATIONS

This application is a continuation-in-part application and claims the benefit or U.S. application Ser. No. 10/139,105, filed May 3, 2002, which claims the benefit of U.S. provisional Application No. 60/288,714, filed May 4, 2001, the disclosures of which are incorporated herein by reference in their entirety.

### FIELD OF THE INVENTION

The present invention concerns methods, compounds and compositions useful for the control of insect pests.

### BACKGROUND OF THE INVENTION

Bacillus thuringiensis (BT) is the first successful example of using a protein to control an agricultural insect pest, and opens the door for a new generation of agricultural pest control that could potentially eliminate chemical pesticides. However, with growing concern over the use of transgenic plants expressing the BT protein along with evidence that insects can develop resistance to BT, non-transgenic protein alternatives to BT are being sought.

BT is an unusual case because it acts directly on the midgut wall of insects when digested, disrupting digestive system function and ultimately causing death. While numerous other toxic peptides are known that are attractive candidates for pest control, currently there is no technology available to enhance the movement of peptides (including proteins) across the gut of insect pests. For many peptides, it is necessary for the compound to cross the gut into the insect hemolymph (blood) for it to be toxic to the insect. The only related method currently available is to develop transgenic baculoviruses that can infect insects. When the virus replicates in the host, the foreign gene is then expressed. The disadvantages of this approach, however, are many, and include slow action, high production cost, poor stability of the living virus, a narrow host range for the virus, and the necessity to release transgenic viruses into the environment. The latter is especially problematic because of the growing public concern about the release of transgenic organisms and the possible negative consequences either real or perceived. In view of the foregoing, there remains a need for new non-transgenic Insecticidal compounds and methods of delivering the same.

### SUMMARY OF THE INVENTION

In general, the present invention provides an Insecticidal compound comprising an Insecticidal peptide (and/or nucleic acid construct) conjugated (preferably covalently conjugated) to a soluble polymer. The nucleic acid construct may be nucleic acids including nucleic acids with proteins associated (e.g., an encapsidated virus). The polymer may be a hydrophilic polymer (i.e., water soluble polymers), lipophilic polymer (i.e., fat soluble polymer), or a combination thereof (i.e., polymers with both lipophilic and hydrophilic groups associated therewith). Examples of suitable Insecticidal peptides include, but are not limited to, juvenile hormone esterases and a variety of toxins such as neurotoxins. Examples of Insecticidal nucleic acid constructs include, but are not limited to, derivatives of baculoviruses or other insect pathogens.

The present invention further provides an Insecticidal compound comprising an insecticide conjugated to a soluble polymer. Examples of suitable insecticides include, but are not limited to, spinosad, acetamiprid and fipronil.

Another aspect of the subject invention is a method for controlling pests, particularly insect pests, comprising administering to said pest a pesticidally effective amount of an insecticidal compound as described above. Any suitable insect pest may be controlled by the methods of the invention, including lepidopteran pests such as moths.

A more general aspect of the invention is a method of facilitating the transport or increasing the amount or rate of transport of a peptide or nucleic acid or insecticide of interest across an insect gut wall, from the insect digestive tract and into the insect hemolymph, while retaining biological activity of the peptide or nucleic acid or insecticide once in the insect hemolymph, by conjugating the peptide or nucleic acid or insecticide of interest to a polymer as described herein to form a conjugate, and then administering that conjugate to the insect as described herein.

The subject compounds can also be used to control pests of agricultural crops (including forest crops or trees), for example by applying the compounds to the agricultural crops. These pests include, for example, coleopterans (beetles), lepidopterans (caterpillars; moths), mites, and nematodes. The compounds of the subject invention can also be used to control household pests including, but not limited to, ants and cockroaches.

The subject invention provides pest control compositions comprising pesticidal (e.g., insecticidal) compounds and a suitable pesticidal carrier. The pest control compositions are formulated for application to the target pests or their situs.

A still further aspect of the present invention is the use of pesticidal (e.g., insecticidal) compounds as described herein for the preparation of a formulation for carrying out the insect control methods described herein.

The foregoing and other objects and aspects of the present invention are explained in greater detail in the specification set forth below.

### DETAILED DESCRIPTION OF THE PREFERRED EMBODIMENTS

As used herein, the term “pesticidally effective” is used to indicate an amount or concentration of a pesticidal compound which is sufficient to reduce the number of pests in a geographical locus as compared to the number of pests in a corresponding geographical locus in the absence of the amount or concentration of the pesticidal compound. Also as used herein, the term Insecticidal compound is an example of a pesticidal compound and the two terms may be used interchangeably.

The terms “pesticidal” and “Insecticidal” as used herein are not intended to refer only to the ability to kill pests, such as insect pests, but also include the ability to interfere with a pest's life cycle in any way that results in an overall reduction in the pest population. For example, the term “pesticidal” includes inhibition of a pest from progressing from one form to a more mature form, e.g., transition between various larval instars or transition from larva to pupa or pupa to adult. Further, the term “pesticidal” is intended to encompass anti-pest activity during all phases of a pest's life cycle; thus, for example, the term includes larvacidal, ovicidal, and adulticidal activity.

1. Insects.

“Insect pest” as used herein refers generally to any insect of the phylum Arthropoda. Examples include plant insect pests and animal insect pests. The plant pests that can be controlled by the compounds of the subject invention include pests belonging to the orders Coleoptera, Lepidoptera, Hemiptera and Thysanoptera. Other pests that can be controlled according to the subject invention include members of the orders Diptera, Siphonaptera, Hymenoptera and Phthiraptera. Other pests that can be controlled by the compounds of the subject invention include those in the family Arachnida, such as ticks, mites, mosquitoes, cockroaches, and spiders.

The terms “lepidoptera” and “lepidopteran” as used herein refers to moths and butterflies, (preferably but not exclusively when in the caterpillar stage) including but not limited to corn borers, gypsy moths, meal moths, clothes moth, brown house moths, white-shouldered house moths, etc.

The term “mosquito” as used herein concerns any type of mosquito (e.g., Anopheles, Aedes, and Culex), including but not limited to Tiger mosquitoes, Aedes aboriginis, Aedes aegypti, Aedes albopictus, Aedes cantator, Aedes sierrensis, Aedes sollicitans, Aedes squamiger, Aedes sticticus, Aedes vexans, Anopheles quadrimaculatus, Culex pipiens, and Culex quinquefaxciatus.

The term “tick” as used herein includes any type of tick, including but not limited to, deer ticks (Ixodes scapularis), the American dog tick (Dermacentor variabilis), Ornithodoros parkeri, O. moubata, and Dermacentor andersoni.

The term “cockroach” as used herein refers to any type of cockroach, including but not limited to the American cockroach (Periplaneta americana), German cockroach (Blattella germanica), oriental cockroach (Blatta orientalis), wood cockroach (Parcoblatta pennsylvanica), brownbanded cockroach (Supella longipalpa), and smokybrown cockroach (Periplaneta fuliginosa).

Other insects that can be treated by the methods of the present invention include, but are not limited to: lice (Order Phthiraptera), such as head and body lice of humans (Pediculus humanus capitis and P. H humanus); Fleas (Order Siphonaptera), such as cat and dog fleas (Ctenocephalides ssp.) and human fleas (Echidnophaga, Pulex ssp.); Bees, wasps, and ants (Order Hymenoptera); mites such as Sarcoptes scabei (human itch mite) and the North American chigger or red bug, Trombicula ssp.; nematodes such as human parasitic nematodes; Silverfish (Order Thysanura), such as Lepisma saccharina, firebrat, and Thermobia domestica; Termites (Order Isoptera) such as Reticulitermes flavipes, Incisitermes minor, Marginitermes hubbardi, and Cryptotermes brevis; Earwigs (Order Dermaptera); Psocids (Order Psocoptera) such as booklice; Beetles (Order Coleoptera), particularly wood eating beetles; Centipedes such as Lithobius, Geophilus, Scutigera; millipides such as Julus terrestris; and Scorpions such as Centruroides sculpturatus and Mastigoproctus gianteus; etc.

2. Insecticidal Peptides.

Peptides with insecticidal activity that can be used to carry out the present invention (insecticidal peptides) include, but are not limited to, Juvenile Hormone Esters (JHE) (this term including mutants thereof), Bacillus thuringiensis toxins, any of a variety of insect toxins (particularly neurotoxins), Trypsin Modulating Oostatic Factor (TMOF) and analogs thereof, etc. Various examples of suitable Insecticidal peptides are discussed in greater detail below.

A. Juvenile hormone esterases. Juvenile hormone esters (JHE) is an insect protein, which appears at critical times in the insect's life. It appears to present no risk to other groups of organisms. It is nonlethal to an individual cell, which allows and perhaps encourages viral replication; yet the enzyme will fatally disrupt the normal development of the organism.

JHE is known. U.S. Pat. No. 5,098,706 exemplifies the administration of an affinity purified JHE enzyme to insects, which results in anti-juvenile hormone activity. Such anti-juvenile hormone activity is effectively lethal, for example in blocking damage by herbivorous insects.

U.S. Pat. No. 5,674,747 to Hammock et al. sets out the coding sequence for several cDNAs of JHE. These coding sequences are for juvenile hormone esters from Heliothis virescens, although there is homology to Helicoverpa zea (formerly Heliothis zea), to Tricoplusia ni and (at lower stringency) hybridization to Manduca sexta. Further, JHE isolated (or derived) from Heliothis (Helicoverpa) viresens functions to hydrolyze every known form of JH. This means that a coding sequence for JHE derived from H. virescens can be used to isolate the gene or the message from a variety of species.

The term “juvenile hormone esters” as used herein includes mutants or analogs of the naturally occurring proteins. Several useful JHE mutants are described in PCT Application WO 94/03588 of Hammock et al., published Feb. 17, 1994. Two mutants described therein are double lysine mutants (K29R, K522R) where the normal lysines of JHE at position 29 and position 522 were changed to arginine by site-directed mutagenesis. Another mutant described was where serine 201 was changed to glycine and the mutant designated “S201G.” The Insecticidal activity of the catalytically deficient S201G mutant of JHE provided similar time for 50% death of test insects to scorpion toxins (when engineered in AcNPV). Thus, the naturally occurring JHE insect protein, which is not normally toxic, can be modified by means such as site-directed mutagenesis (or otherwise) to a toxic agent. In addition to amino acid residue changes, other JHE mutants can be prepared such as by deleting the N-terminal 19 amino acids, which are a signal sequence for the newly made protein to enter the secretory pathway, become glycosylated, and exit the cell.

B. Bacillus thuringiensis Insecticidal peptides. The present invention can be carried out using Insecticidal peptides or toxins obtained from any of a variety of Bacillus thuringiensis strains. These toxins are well known. For example, U.S. Pat. No. 4,448,885 to Schnepf et al. and U.S. Pat. No. 4,467,036 to Schnepf et al. describe the expression of Bacillus thuringiensis crystal protein in Escherichia coli. U.S. Pat. No. 4,918,006 to Ellar et al. describes an isolated DNA encoding such toxins. Additional examples of such toxins that may be used to carry out the invention are described below.

U.S. Pat. No. 5,847,079 to Payne (Mycogen) provides a purified toxin produced by Bacillus thuringiensis PS192N 1, having all the identifying characteristics of NRRL B-18721, the toxin having activity against dipteran pests.

U.S. Pat. No. 5,298,245 to Payne et al. (Mycogen) describes Bacillus thuringiensis PS92J, having all the identifying characteristics of deposit NRRL B-18747; Bacillus thuringiensis PS196S1, having all the identifying characteristics of deposit NRRL B-18748; Bacillus thuringiensis PS201L1, having all the identifying characteristics of deposit NRRL B-18749; and Bacillus thuringiensis PS201T6, having all the identifying characteristics of deposit NRRL B-18750. Toxins suitable for carrying out the present invention may be isolated from all of these organisms in accordance with known techniques and used to carry out the present invention.

U.S. Pat. No. 4,948,734 to Edwards et al. (Mycogen) describes nematocidal toxins produced by B. thuringiensis strain PS-17, B. thuringiensis strain PS-33F2, B. thuringiensis strain PS-52A1, B. thuringiensis strain PS-63B, and B. thuringiensis strain PS-69D1.

U.S. Pat. No. 5,151,363 to Payne (Mycogen); Bacillus thuringiensis strain PS80JJ1, having an accession number NRRL B-18679; Bacillus thuringiensis strain PS158D5, having an accession number NRRL B-18680; Bacillus thuringiensis strain PS167P, having an accession number NRRL B-18681; Bacillus thuringiensis strain PS169E, having an accession number NRRL B-18682; Bacillus thuringiensis strain PSi 77F 1, having an accession number NRRL B-18683; Bacillus thuringiensis strain PSi 77G, having an accession number NRRL B-18684; Bacillus thuringiensis strain PS204G4, having an accession number NRRL B-18685; and Bacillus thuringiensis strain PS204G6, having an accession number NRRL B-18686, from all of which toxins having nematocidal activity may be produced.

C. Insect toxins. Numerous insect toxins that may be used to carry out the present invention are described in U.S. Pat. No. 6,162,430 to Hammock et al. For example, the insect toxin may be a neurotoxin derived from or similar to an arthropod or other invertebrate toxin, such as a scorpion toxin, a wasp toxin, a snail toxin, a mite toxin, or a spider toxin. A useful scorpion toxin is, for example, AaIT from Androctonus australis. Zlotkin et al., Biochimie, 53, 1073-1078 (1971). A useful snail venom is that from the snail Conus querciones, which the animal delivers by mouth and some individual toxins, which appear to be selective for arthropods including insects. See, for example, Olivera et al., “Diversity of Conus Neuropeptides,” Science, 249:257-263 (1990).

As with JHE, the amino acid sequence of the excitatory toxin from Androctonus australis (AaIT) has also been determined, the sequence has been published (Darbon 1982), and the AaIT gene has been cloned and inserted into expression vectors for insect control. (See PCT Application WO 92/11363, published Jul. 9, 1992, inventors Belagaje et al.) The AaIT toxin exhibits toxicity to insects, while being non-toxic to isopods and mammals.

Yet another suitable toxin for practicing the invention affects insect sodium channels in a manner very similar to the effect of α-toxins on mammalian sodium channels. This neurotoxin was derived from a yellow scorpion Leuirus quinquestriatus hebraeus, and is called herein LqhoαIT. The identification and purification of this toxin was described in “A Scorpion Venom Neurotoxin Paralytic to Insects that Affects Sodium Current Inactivation: Purification, Primary Structure, and Mode of Action,” published by Eitan et al., Biochemistry, 29:5941-5947 (1990). Various other scorpion toxins (e.g. the Buthoid scorpion) can also be used, such as LqqIT2, which is a depressive insect toxin from Leiurus quinquestriatus quinquestriatus. The purification method used to obtain this neurotoxin was published by Zlotkin et al., Archives of Biochem. Biophys., 240:877-887 (1985).

BjIT2 is another depressive insect toxin and is from Buthotus judaicus. The purification has been published in Lester et al., Biochim. Biophys. Acta, 701:370-381 (1982). BjIT2 exists in two isoforms which differ in amino acid sequence at position 15. Form 1 has isoleucine in this position while form 2 has valine.

LqhIT2 is yet another depressive insect toxin from Leiurus quinquestriatus hebraeus which was purified using reverse phase HPLC.

Yet other toxins, purified from the venom of the chactoid scorpion, Scorpio maurus palmatus, can also be used. For example, SmpIT2, from the chactoid scorpion, Scorpio maurus palmatus, is a depressive insect toxin. Its purification is described in Lazarovici et al., J. Biol. Chem., 257:8397-8404 (1982).

Still other toxins purified from the venom of the chactoid scorpion, Scorpio maurus palmatus, are SmpCT2 and SmpCT3, and crustacean toxins, whose purification has been described in Lazarovici, Ph.D. thesis (1980), Hebrew University, Jerusalem, “Studies on the Composition and Action of the Venom of the Scorpion Scorpio maurus palmatus (Scorpionidae).”

D. TMOF and TMOF analogs. Serine esterases such as trypsin and trypsin-like enzymes (collectively referred to herein as “TTLE”) are important components of the digestion of proteins by insects. In the mosquito, Aedes aegypti, an early trypsin that is found in the midgut of newly emerged females is replaced, following the blood meal, by a late trypsin. A female mosquito typically weighs about 2 mg and produces 4 to 6 μg of trypsin within several hours after ingesting a blood meal. Continuous biosynthesis at this rate would exhaust the available metabolic energy of a female mosquito; as a result, the mosquito would be unable to produce mature eggs, or even to find an oviposition site. To conserve metabolic energy, the mosquito regulates TTLE biosynthesis with a peptide hormone named Trypsin Modulating Oostatic Factor (TMOF). Mosquitoes produce TMOF in the follicular epithelium of the ovary 12-35 hours after a blood meal; TMOF is then released into the hemolymph where it binds to a specific receptor on the midgut epithelial cells, signaling the termination of TTLE biosynthesis.

This regulatory mechanism is not unique for mosquitoes; flesh flies, fleas, sand flies, house flies, dog flies and other insect pests which need protein as part of their diet have similar regulatory mechanisms. Following the 1985 report, the isolated hormone, (a ten amino acid peptide) and two TMOF analogues were disclosed in U.S. Pat. Nos. 5,011,909 and 5,130,253. These were: YDPAP₆; DYPAP₆; and NPAP₆.

Additionally, U.S. Pat. No. 5,358,934 discloses truncated forms of the full length TMOF which have prolines removed from the carboxy terminus, including the peptides: YDPAP, YDPAPP, YDPAPPP, and YDPAPPPP.

Further, D. Borovsky and R. Linderman, PCT Patent Application WO 00/63233, published Oct. 26, 2000, discloses additional TMOF analogs that can be used to carry out the present invention. In general, these are compounds of the formula: A¹A²A³A⁴A⁵F (Formula I), wherein:

A¹ is selected from the group consisting of A, D, F, G, M, P, and Y;

A² is selected from the group consisting of A, D, E, F, G, N, P, S, and Y;

A³ is optionally present and is selected from the group consisting of A, D, F, G, L, P, S and Y;

A⁴ is optionally present when A³ is present and is selected from the group consisting of A, F, G, L, and Y;

A⁵ is optionally present when A⁴ is present and is selected from the group consisting of A, F, L, and P; and

F is a flanking region which is optionally present and is selected from the group consisting of P, PP, PPP, PPPP and PPPPP.

The peptides used herein can be prepared by well-known synthetic procedures. For example, the peptides can be prepared by the well-known Merrifield solid support method. See, e.g., Merrifield, Science 150:178-185 (1965). This procedure, though using many of the same chemical reactions and blocking groups of classical peptide synthesis, provides a growing peptide chain anchored by its carboxyl terminus to a solid support, usually cross-linked polystyrene or styrenedivinylbenzene copolymer. This method conveniently simplifies the number of procedural manipulations since removal of the excess reagents at each step is effected simply by washing of the polymer.

Alternatively, these peptides can be prepared by use of well-known molecular biology procedures. DNA sequences encoding the peptides of the invention can be synthesized readily because the amino acid sequences are disclosed herein. These DNA sequences are a further aspect of the subject invention. These genes can be used to genetically engineer, for example, bacteria, insect viruses, plant cells, or fungi for synthesis of the peptides of the invention.

As described in U.S. Pat. No. 5,358,934, in all of the foregoing peptides, the C-terminus of the peptide may be amidated, the N-terminus of the peptide may be acetylated, and/or the peptide may be bound to a lipid.

E. Nucleic acid constructs. Nucleic acids or nucleic acid constructs that may be used to carry out the invention include any derivatives of baculoviruses or other insect pathogens consisting of its nucleic acids alone or its nucleic acid and protein components together that might not be toxic to the insect from the outside but when transferred into the insect blood by this invention would cause mortality or disrupt development. The nucleic acids can be transgenic, containing the message for toxins or other proteins as mentioned before. An example would be a derivative of a baculovirus or transgenic baculovirus that is only pathogenic (or toxic) when transported into the insect hemolymph by this invention. A further example would be a non-occluded baculovirus or a derivative thereof. This would not be limited to insect pathogen derivatives but any nucleic acid construct with or without a protein component which would not be toxic to the insect from the outside but when transported into the insect blood by this invention would be toxic to the insect. Examples of viruses that may be conjugated to a polymer in accordance with the invention include, but are not limited to, those described in U.S. Pat. No. 6,221,632 to Iatrou, U.S. Pat. No. 6,156,309 to Miller et al., and U.S. Pat. No. 6,096,304 to McCutchen. Nucleic acids can be conjugated to a polymer by any suitable means, such as direct coupling to the nucleic acid or coupling to a protein or peptide associated with the nucleic acid (e.g., coupling to a viral capsid).

3. Insecticides

The present invention also provides insecticidal compounds comprising an insecticide conjugated to a soluble polymer. The insecticide of this invention can be, but is not limited to, one or more than one of the insecticides listed in Table I (as compiled from Rose et al. 1999. “Pesticides,” pp. 663-697, in Toxicology, Marquardt et al., Eds., Academic Press, San Diego; internet site: www.alanwwood.net, “Compendium of Pesticide Common Names”) in any combination. Additional examples of an insecticide of this invention include chlorfenapyr, closantel, crotamiton, diafenthiuron, EXD, fenazaflor, fenoxacrim, flucofuron, hydramethylnon, isoprothiolane, malonoben, metoxadiazone, nifluridide, pyridaben, pyridalyl, rafoxanide, sulcofuron, triarathene and triazamate. These lists are exemplary only and are not intended to be inclusive of all insecticides that can be used in the compounds and methods of this invention. The advantage of employing these insecticides in the compositions of the present invention is that a lower concentration of insecticide can be used to achieve the desired insecticidal effect, as compared to the amount of the insecticide needed to achieve the same effect when the insecticide is administered or distributed in the absence of conjugation to a polymer of this invention.

4. Conjugates with Polymers

Polymers that may be used to carry out the present invention are, in general, naturally occurring polymers such as polysaccharides, or synthetic polymers such as polyalkylene oxides such as polyethylene glycol (PEG), polyalkylene glycols, polyoxyethylated polyols, polyvinylpyrrolidone, polyacrylates such as polyhydroxyethyl methacrylate, polyvinyl alcohols, and polyurethane. The polymers may be linear or branched and may be substituted or unsubstituted. The polymers may, as noted above, be hydrophilic, lipophilic, or both hydrophilic and lipophilic.

Examples of lipophilic polymers include, but are not limited to, polyvinyl acetate, polyvinyl chloride, polyvinyl butyral, polymethacrylate, cellulose triacetate and cellulose nitrate (see, e.g., U.S. Pat. No. 5,800,624).

In another embodiment of the invention, the polymer may be a lipid. By lipid is meant one of a class of compounds that contains long-chain saturated or unsaturated aliphatic hydrocarbons (typically having 6-25 carbons) and their derivatives, such as fatty acids, alcohols, amines, amino alcohols, and aldehydes. The classes of lipids include glycolipids, phospholipids and sphingolipids. Glycolipids are lipids that additionally contain carbohydrate units. Phospholipids are lipids containing esters of phosphoric acid containing one or two molecules of fatty acid or fatty alkyl ethers, an alcohol, and generally a nitrogenous base. Sphingolipids are lipids, such as sphingomyelin, that yield sphingosine or one of its derivatives as a product of hydrolysis. Alternatively, the polymer may be a lipid vesicle, such as a liposome or lipoprotein (See, e.g., U.S. Pat. No. 6,162,931).

In general, the present invention is employed when the peptide or nucleic acid or insecticide does not ordinarily cross the insect gut into the insect hemolymph (blood) in toxic form. The polymer facilitates the crossing of the peptide or nucleic acid or insecticide across the insect gut into the insect hemolymph in an amount sufficient to render the peptide or nucleic acid or insecticide toxic to the insect (e.g., when the compound is ingested by the insect).

In general, the polymer portion of the molecule has an average molecular weight between 100, 500 or 1,000 kiloDaltons up to 10,000, 50,000, 100,000 or 200,000 kiloDaltons. Any suitable amount of the polymer may be conjugated to the peptide or nucleic acid or insecticide, for example with the polymer being conjugated to the peptide or nucleic acid or insecticide in a molar ratio of about 1: 20, 1:10, 1:5 or 1:1 up to about 10: 1 or 20:1.

The particular manner and site of covalent linkage to the peptide or nucleic acid or insecticide will depend upon factors such as the polymer employed, the usage of linking groups, chemical reactions, etc., but may be carried out in accordance with known techniques. A variety of particular examples that can be used to carry out the present invention with Insecticidal peptides, nucleic acids or insecticides as described above are set forth in greater detail below.

The covalent linkage between a peptide or nucleic acid or insecticide of this invention and a polymer of this invention can be via a cleavable linkage group. The cleavable linkage can be cleaved by a variety of mechanisms, including, but not limited to, enzymatic cleavage, chemical cleavage (e.g., using pH for acid or base labile groups, heat or other physical conditions) and photoactivated cleavage (e.g., using light). Examples of a cleavable linkage group of this invention include, but are not limited to, ester [O(C═O)—], amide [NH(C═O)—], amine [N═], urethane [O(C═O)NH—or O(C═O)N═], carbonate [O(C═O)O—], thio-carbonate [O(C═O)S—] and ether [O—]. Additional examples of the cleavable linkage group of this invention include o-nitroarylmethine, arylaroylmethine, dialkoxysilane, β-cyano ether, amino carbamate, dithoacetal, disulfide, and derivatives thereof. (See also, Ihre et al., 2002. Bioconjugate Chem. 13:443-452, the entire contents of which are incorporated herein for teachings of the preparation of a compound comprising a cleavable linkage group.)

U.S. Pat. No. 4,003,792 to Mill et al. describes conjugates of a peptide and an acid polysaccharide (for example, selected from the group consisting of pectin, pectic acid, alginic acid, celluronic acid, lichenin uronic acid, and carrageenane), which polysaccharide may be bonded covalently by a linkage such as an amide, ester, and a combination of amide and ester bonds to the peptide component.

U.S. Pat. No. 4,766,106 to Katre and Knauf (Cetus) describes a peptide that is covalently conjugated via up to ten amino acid residues on the peptide to a water-soluble polymer selected from the group consisting of polyethylene glycol homopolymers and polyoxyethylated polyols, wherein the homopolymer is unsubstituted or substituted at one end with an alkyl group, and the polyol is unsubstituted and wherein said protein in its unconjugated form is normally hydrophobic. The polymer may be conjugated to the protein via the 4-hydroxy-3-nitrobenzene sulfonate ester or the N-hydroxysuccinimide ester of a carboxylic acid of the polymer. In particular examples, the polymer is an unsubstituted polyethylene glycol homopolymer, a monomethyl polyethylene glycol homopolymer or a polyoxyethylated glycerol.

U.S. Pat. No. 4,894,226 to Aldwin and Nitecki (Cetus) describes a peptide that is covalently conjugated via a flexible spacer arm to polyproline.

U.S. Pat. No. 5,681,811 to Ekwuribe (Protein Delivery, Inc.) describes a peptide covalently coupled with one or more molecules of a non-naturally occurring polymer, the polymer comprising a lipophilic moiety and a hydrophilic polymer moiety. In a preferred embodiment, the non-naturally occurring polymer comprises (i) a linear polyalkylene glycol moiety and (ii) a lipophilic moiety. In a particular embodiment, the compound includes a triglyceride backbone moiety, and the Insecticidal peptide is covalently coupled with the triglyceride backbone moiety through a polyalkylene glycol spacer group bonded at a carbon atom of the triglyceride backbone moiety, and at least one fatty acid moiety is covalently attached either directly to a carbon atom of the triglyceride backbone or covalently joined through a polyalkylene glycol spacer moiety.

U.S. Pat. No. 5,637,749 to Greenwald (Enzon) describes nucleophiles such as enzymes (and for which other peptides can be substituted herein) to which are covalently bonded at least one water-soluble polyalkylene oxide.

U.S. Pat. No. 5,405,877 to Greenwald et al. (Enzon) describes peptides bonded to one or more water soluble polyalkylene oxides, particularly cyclic imide thione activated polyalkylene oxides.

U.S. Pat. No. 5,567,422 to Greenwald (Enzon) describes peptides bonded to water soluble polymers such as a polyalkylene oxide.

U.S. Pat. No. 6,113,906 to Greenwald et al. (Enzon) describes peptides bonded to branched polymers. Particularly preferred branched polymers comprise poly(alkylene oxides) such as poly (ethylene glycol).

Still other examples of polymers that can be covalently conjugated to peptides as described above to produce compounds of the present invention include those described in U.S. Pat. No. 5,446,090 to Harris (Shearwater) and U.S. Pat. No. 5,672,662 to Harris and Kozlowski (Shearwater).

5. Methods and Formulations for the Control of Pests.

The subject invention concerns novel pest control compounds and methods for using such compounds. Specifically exemplified are novel pesticidal (e.g., insecticidal) compounds, compositions comprising said pesticidal compounds and the use of such pesticidal compounds and compositions in controlling pests, particularly insect pests such as moths.

Preferably, the subject compounds have an LD₅₀ against mosquito larvae of less than 3.0 μmole/mL. More preferably, the compounds have an LD₅₀ of less than 2.0 μmole/mL, and, most preferably, the compounds have an LD₅₀ of less than 1.0 μmole/mL. As used herein, “LD₅₀” refers to a lethal dose of a compound such as a peptide or insecticide able to cause 50% mortality of larvae maintained on a diet of 1 mg/mL autoclaved yeast supplemented with the compound.

The use of the compounds of the subject invention to control pests can be accomplished readily by those skilled in the art having the benefit of the instant disclosure. For example, the compounds can be encapsulated, incorporated in a granular form, solubilized in water or other appropriate solvent, powdered, and included into any appropriate formulation for direct application to the pest or to a pest inhabited locus.

Formulated bait granules containing an attractant and the pesticidal compounds of the present invention can be applied to a pest-inhabited locus, such as to the soil. Formulated product can also be applied as a seed-coating or root treatment or total plant treatment at later stages of the crop cycle. Plant and soil treatments can be employed as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like). The formulations can include spreader-sticker adjuvants, stabilizing agents, other pesticidal additives, or surfactants. These formulations can include materials that increase gut porosity to the pesticidal comnpounlds of the present invention, for example detergents, phospholipases, BT israelensis cytotoxin, etc.

Liquid formulations can be aqueous-based or non-aqueous (i.e., organic solvents), or combinations thereof, and can be employed as foams, gels, suspensions, emulsions, microemulsions or emulsifiable concentrates or the like. The ingredients can include rheological agents, surfactants, emulsifiers, dispersants or polymers.

The pesticidal compound concentration will vary widely depending upon the nature of the particular formulation, particularly whether it is a concentrate or to be used directly. The pesticidal compound will be present in the composition by at least about 0.0001% by weight and can be 99 or 100% by weight of the total composition. The pesticidal carrier can be from 0.1% to 99.9999% by weight of the total composition. The dry formulations will have from about 0.0001-95% by weight of the pesticide while the liquid formulations will generally be from about 0.0001-60% by weight of the solids in the liquid phase. These formulations will be administered at about 50 mg (liquid or dry) to 1 kg or more per hectare.

The formulations can be applied to the pest or the environment of the pest, e.g., soil and foliage, by spraying, dusting, sprinkling or the like.

The pesticidal compounds may also be provided in tablets, pellets, briquettes, bricks, blocks and the like which are formulated to float, maintain a specified depth or sink as desired. In one embodiment the formulations, according to the present invention, are formulated to float on the surface of an aqueous medium; in another embodiment they are formulated to maintain a depth of 0 to 2 feet in an aqueous medium; in yet another embodiment the formulations are formulated to sink in an aqueous environment.

The pesticidal compounds of the present invention may be used advantageously to control an insect population of a specific geographical area. The specific geographical area can be as large as a state or a county and is preferably ½ to 10 square miles, more preferably one square mile, and more preferably ½ to one square miles, and may also be much smaller, such as 100-200 square yards, or may simply include the environment surrounding and/or inside an ordinary building, such as a barn or house.

In general, the pesticidal compounds or compositions containing one or more of the pesticidal compounds are introduced to an area of infestation. For example, the composition can be sprayed on as a wet or dry composition on the surface of organic material infested with a target pest, or organic material or habitat susceptible to infestation with a target pest. Alternately, the composition can be applied wet or dry to an area of infestation where it can come into contact with the target pest. The pesticidal compound may also be applied to an area of larvae development, for example, an agricultural area or a body of water such as a pond, rice paddy, watering hole or even a small puddle.

In one aspect of the invention, a target pest population is exposed to a pesticidally effective amount of a pesticidal compound to decrease or eliminate the population of that pest in an area. The method of introduction of the pesticidal compound into the target pest can be by direct ingestion by the target pest from a trap, or by feeding of a target pest on nutrient-providing organic matter treated with the pesticidal compound, (e.g., killed yeast or algae in the case of mosquito larvae). For some applications it will be advantageous to deliver the pesticidal composition to the location of the pest colony. In other applications, it will be preferable to apply the pesticidal composition to a prey or host of the pest, such as a human or other animal.

Amounts and locations for application of the pesticidal compounds and compositions of the present invention are generally determined by the habits of the insect pest, the lifecycle stage at which the pest is to be attacked, the site where the application is to be made and the physical and functional characteristics of the compound.

The pesticidal compounds of the present invention are generally administered to the insect by oral ingestion, but may also be administered by means which permit penetration through the cuticle or penetration of the insect respiratory system. The pesticide may be absorbed by the pest, particularly where the composition provides for uptake by the outer tissues of the pest, particularly a larval or other pre-adult form of the pest, such as a detergent composition.

Where the pesticidal compounds are formulated to be orally administered to the insect pests, the compounds can be administered alone or in association with an insect food. The compounds are preferably so associated with the food that it is not possible for the insect to feed on the food without ingesting the pesticidal compound. Preferred foods for mosquito larvae are algae (particularly green, unicellular) and yeast. The food may comprise live organisms or killed organisms. In one embodiment for the control of plant pests, plants or other food organisms may be genetically transformed to express the pesticidal compound such that a pest feeding upon the plant or other food organism will ingest the pesticidal compound and thereby be controlled. The pesticidal compound may also be mixed with an attractant to form a bait that will be sought out by the pest. Further, the pesticidal compound may be applied as a systemic poison that is absorbed and distributed through the tissues of a plant or animal host, such that an insect feeding thereon will obtain an insecticidally effective dose of the pesticidal compound.

The compounds according to the present invention comprising peptides, nucleic acids and/or insecticides may be employed alone or in mixtures with one another in any combination and/or with such solid and/or liquid dispersible carrier vehicles as described herein or as otherwise known in the art, and/or with other known compatible active agents, including, for example, insecticides, acaricides, rodenticides, fungicides, bactericides, nematocides, herbicides, fertilizers, growth-regulating agents, etc., if desired, in the form of particular dosage preparations for specific application made therefrom, such as solutions, emulsions, suspensions, powders, pastes, and granules as described herein or as otherwise known in the art which are thus ready for use. For example, a dosage form for a pond environment may be provided in the form of time releasable bricks, briquettes, pellets, powders, liquids, and the like, comprising at least one pesticidal compound according to the present invention and at least one other active ingredient selected from the group consisting of insecticides, acaricides, rodenticides, fungicides, bactericides, nematocides, herbicides, fertilizers, and growth-regulating agents, for administration to the pond.

The pesticidal compounds may be administered with other insect control chemicals, for example, the compositions of the invention may employ various chemicals designed to affect insect behavior, such as attractants and/or repellents, or as otherwise known in the art. The pesticidal compounds may also be administered with chemosterilants.

The pesticidal compounds are suitably applied by any method known in the art including, for example, spraying, pouring, dipping, in the form of concentrated liquids, solutions, suspensions, sprays, powders, pellets, briquettes, bricks and the like, formulated to deliver a pesticidally effective concentration of the pesticidal compound. The pesticidal formulations may be applied in a pesticidally effective amount to an area of pest infestation or an area susceptible to infestation, a body of water or container, a barn, a carpet, pet bedding, an animal, clothing, skin, and the like. As used herein, a pesticidally effective or insecticidally effective amount or concentration of a compound of this invention can also be identified as an amount or concentration which controls the target pest, wherein said control can be for example, a reduction in a deleterious effect of the targeted pest (e.g., reduction in the spread of disease or contamination or infestation) or a reduction in the population of the pest or area infested by the targeted pest.

Formulated pesticidal compounds can also be applied as a seed-coating or root treatment or total plant treatment at later stages of the crop cycle.

Plant and soil treatments may be employed as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like). Such formulations suitably include spreader-sticker adjuvants, stabilizing agents, other pesticidal additives, or surfactants.

Liquid formulations may be aqueous-based or non-aqueous and employed as foams, gels, suspensions, emulsifiable concentrates, or the like.

The pesticidal compounds and compositions of the present invention can be delivered to the environment using a variety of devices known in the art of pesticide administration; particularly preferred devices are those which permit continuous extended or pulsed extended delivery of the pesticidal composition. For example, U.S. Pat. No. 5,417,682 discloses a fluid-imbibing dispensing device for the immediate, or almost immediate, and extended delivery of an active agent over a prolonged period of time together with the initially delayed pulse delivery of an active agent to a fluid environment of use.

Other dispensing means useful for dispensing the pesticidal compositions of the present invention include, for example, osmotic dispensing devices which employ an expansion means to deliver an agent to an environment of use over a period of hours, weeks, days or months. The expansion means absorbs liquid, expands, and acts to drive out beneficial agent composition from the interior of the device in a controlled, usually constant manner. An osmotic expansion device can be used to controllably, usually relatively slowly and over a period of time, deliver the pesticidal compositions of the present invention. The osmotic expansion device may be designed to float on water and deliver the pesticidal compound to the surface of the water.

The compositions of the present invention may also be employed as time-release compositions, particularly for applications to animals, or areas that are subject to reinfestation, such as mosquito-infested ponds or animal quarters. Various time-release formulations are known in the art. Common analytical chemical techniques are used to determine and optimize the rate of release to ensure the delivery of a pesticidally effective concentration of the pesticidal compound. The amount of the time-release composition necessary to achieve a pesticidally effective concentration of pesticide in the environment where the pesticide is applied, e.g., a body of water, is based on the rate of release of the time-release formulation. In one aspect, the time-release formulations may be formulated to float on top of the water. In another aspect, the formulation may be formulated to rest on the bottom, or below the surface of the body of water, and to gradually release small particles which themselves float to the surface, thereby delivering the pesticidal composition to the niche of the pest, e.g., mosquito larvae.

Delayed or continuous release can also be accomplished by coating the pesticidal compounds or a composition containing the pesticidal compound(s) with a dissolvable or bioerodable coating layer, such as gelatin, which coating dissolves or erodes in the environment of use, such as in a pond, to then make the pesticidal compound available, or by dispersing the compounds in a dissolvable or erodable matrix.

Such continuous release and/or dispensing means devices may be advantageously employed in a method of the present invention to consistently maintain a pesticidally effective concentration of one or more of the pesticidal compounds of the present invention in a specific pest habitat, such as a pond or other mosquito-producing body of water The continuous release compositions are suitably formulated by means known in the art to float on a body of water, thereby delivering the pesticidal compound to the surface layer of the water inhabited by insect larvae.

### EXAMPLE 1

### Tobacco Budworm Larvae

The present invention was tested by administering a detectable peptide conjugated to a lipophilic polymer to tobacco budworms (Heliothis virescens). Administration was carried out by mealpad degradation, injection, and cuticular passage. Unconjugated protein was administered as a control.

The methodology used to introduce the control and treatment orally into tobacco budworm larvae was carried out in accordance with known procedures (see, e.g., R. M. Roe, W. D. Bailey, F. Gould and G G Kennedy, “Insecticide Resistance Assay” (U.S. Pat. No. 6,060,039, May 9, 2000)). Detectable peptide in an aqueous solution or detectable peptide conjugated to a lipophilic group in an aqueous solution was added to a dehydrated meal pad. The synthesis of these meal pads was carried out in accordance with known techniques (see, e.g., J. Econ. Entomol, 94: 76-85 (2001)). This addition produces a completely hydrated meal pad with the test compounds evenly distributed throughout the insect meal. Then larvae are allowed to feed ad libitum on this food source in bioassay containers.

Insect larvae were injected with test compounds in an aqueous solution directly into the insect hemocoel using a Hamilton repeater syringe fitted with a 50 microliter glass syringe that delivers 1 microliter of the test material in aqueous solution per repeat cycle. Any insect which bled after the injection was discarded. Insects were then allowed to feed ad libitum on standard insect diet.

Test materials were topically applied in DMSO directly on the insect cuticle and the insect then allowed to feed ad libitum on standard insect diet.

For all three routes of administration, substantially more of the detectable protein was observed in the budworm hemolymph when the detectable protein was conjugated to a lipophilic polymer than when it was not.

The foregoing is illustrative of the present invention, and is not to be construed as limiting thereof. The invention is defined by the following claims, with equivalents of the claims to be included therein.

TABLE I

| I. | Nereistoxin analogue insecticides | | | |
|---|---|---|---|---|
| | A. | bensultap | | |
| | B. | cartap | | |
| | C. | thiocyclam | | |
| | D. | thiosultap | | |
| II. | Antibiotic insecticides | | | |
| | A. | abamectin | | |
| | B. | allosamidin | | |
| | C. | doramectin | | |
| | D. | emamectin | | |
| | E. | eprinomectin | | |
| | F. | ivermectin | | |
| | G. | milbemectin | | |
| | H. | selamectin | | |
| | I. | spinosad | | |
| | J. | thuringiensin | | |
| III. | Arsenical insecticides | | | |
| | A. | calcium arsenate | | |
| | B. | copper acetoarsenite | | |
| | C. | copper arsenate | | |
| | D. | lead arsenate | | |
| | E. | potassium arsenite | | |
| | F. | sodium arsenite | | |
| IV. | Nicotinoid insecticides | | | |
| | A. | flonicamid | | |
| | B. | nitroguanidine insecticides | | |
| | | 1 | clothianidin | |
| | | 1. | dinotefuran | |
| | | 2. | thiamethoxam | |
| | C. | nitromethylene insecticides | | |
| | | 1. | nitenpyram | |
| | | 2. | nithiazine | |
| | D. | pyridylmethylamine insecticides | | |
| | | 1. | acetamiprid | |
| | | 2. | imidacloprid | |
| | | 3. | nitenpyram | |
| | | 4. | thiacloprid | |
| V. | Botanical insecticides | | | |
| | A. | anabasine | | |
| | B. | azadirachtin | | |
| | C. | d-limonene | | |
| | D. | nicotine | | |
| | E. | pyrethrins | | |
| | | 1. | cinerin I | |
| | | 2. | cinerin II | |
| | | 3. | jasmolin I | |
| | | 4. | jasmolin II | |
| | | 5. | pyrethrin I | |
| | | 6. | pyrethrin II | |
| | F. | quassia | | |
| | G | rotenone | | |
| | H. | ryania | | |
| | I. | sabadilla | | |
| VI. | Organochlorine insecticides | | | |
| | A. | bromo-DDT | | |
| | B. | camphechlor | | |
| | C. | DDT | | |
| | | 1. | pp′-DDT | |
| | D. | ethyl-DDD | | |
| | E. | HCH | | |
| | | 1. | gamma-HCH | |
| | | 2. | lindane | |
| | F. | methoxychlor | | |
| | G. | pentachlorophenol | | |
| | H. | TDE | | |
| | I. | cyclodiene insecticides | | |
| | | 1. | aldrin | |
| | | 2. | chlorbicyclen | |
| | | 3. | chlordane | |
| | | 4. | chlordecone | |
| | | 5. | dieldrin | |
| | | 6. | dilor | |
| | | 7. | endosulfan | |
| | | 8. | endrin | |
| | | 9. | HEOD | |
| | | 10. | heptachlor | |
| | | 11. | HHDN | |
| | | 12. | isobenzan | |
| | | 13. | isodrin | |
| | | 14. | kelevan | |
| | | 15. | mirex | |
| VII. | Carbamate insecticides | | | |
| | A. | bendiocarb | | |
| | B. | carbaryl | | |
| | C. | benzofuranyl methylcarbamate insecticides | | |
| | | 1. | benfuracarb | |
| | | 2. | carbofuran | |
| | | 3. | carbosulfan | |
| | | 4. | decarbofuran | |
| | | 5. | furathiocarb | |
| | D. | dimethylcarbamate insecticides | | |
| | | 1. | dimetan | |
| | | 2. | dimetilan | |
| | | 3. | hyquincarb | |
| | | 4. | pirimicarb | |
| | E. | oxime carbamate insecticides | | |
| | | 1. | alanycarb | |
| | | 2. | aldicarb | |
| | | 3. | aldoxycarb | |
| | | 4. | butocarboxim | |
| | | 5. | butoxycarboxim | |
| | | 6. | methomyl | |
| | | 7. | nitrilacarb | |
| | | 8. | oxamyl | |
| | | 9. | tazimcarb | |
| | | 10. | thiocarboxime | |
| | | 11. | thiodicarb | |
| | | 12. | thiofanox | |
| | F. | phenyl methylcarbamate insecticides | | |
| | | 1. | allyxycarb | |
| | | 2. | aminocarb | |
| | | 3. | bufencarb | |
| | | 4. | butacarb | |
| | | 5. | carbanolate | |
| | | 6. | cloethocarb | |
| | | 7. | dicresyl | |
| | | 8. | dioxacarb | |
| | | 9. | EMPC | |
| | | 10. | ethiofencarb | |
| | | 11. | fenethacarb | |
| | | 12. | fenobucarb | |
| | | 13. | isoprocarb | |
| | | 14. | methiocarb | |
| | | 15. | metolcarb | |
| | | 16. | mexacarbate | |
| | | 17. | promacyl | |
| | | 18. | promecarb | |
| | | 19. | propoxur | |
| | | 20. | trimethacarb | |
| | | 21. | XMC | |
| | | 22. | xylylcarb | |
| VIII. | Organophosphorus insecticides | | | |
| | A. | organophosphate insecticides | | |
| | | 1. | bromfenvinfos | |
| | | 2. | chlorfenvinphos | |
| | | 3. | crotoxyphos | |
| | | 4. | dichlorvos | |
| | | 5. | dicrotophos | |
| | | 6. | dimethylvinphos | |
| | | 7. | fospirate | |
| | | 8. | heptenophos | |
| | | 9. | methocrotophos | |
| | | 10. | mevinphos | |
| | | 11. | monocrotophos | |
| | | 12. | naled | |
| | | 13. | naftalofos | |
| | | 14. | phosphamidon | |
| | | 15. | propaphos | |
| | | 16. | schradan | |
| | | 17. | TEPP | |
| | | 18. | tetrachlorvinphos | |
| | B. | organothiophosphate insecticides | | |
| | | 1. | dioxabenzofos | |
| | | 2. | fosmethilan | |
| | | 3. | phenthoate | |
| | C. | aliphatic organothiophosphate insecticides | | |
| | | 1. | acethion | |
| | | 2. | amiton | |
| | | 3. | cadusafos | |
| | | 4. | chlorethoxyfos | |
| | | 5. | chlormephos | |
| | | 6. | demephion | |
| | | | a. | demephion-O |
| | | | b. | demephion-S |
| | | 7. | demeton | |
| | | | a. | demeton-O |
| | | | b. | demeton-S |
| | | 8. | demeton-methyl | |
| | | | a. | demeton-O-methyl |
| | | | b. | demeton-S-methyl |

| | | 9. | demeton-S-methylsulphon |
|---|---|---|---|
| | | 10. | disulfoton |
| | | 11. | ethion |
| | | 12. | ethoprophos |
| | | 13. | IPSP |
| | | 14. | isothioate |
| | | 15. | malathion |
| | | 16. | methacrifos |
| | | 17. | oxydemeton-methyl |
| | | 18. | oxydeprofos |
| | | 19. | oxydisulfoton |
| | | 20. | phorate |
| | | 21. | sulfotep |
| | | 22. | terbufos |
| | | 23. | thiometon |
| | D. | aliphatic amide organothiophosphate insecticides | |
| | | 1. | amidithion |
| | | 2. | cyanthoate |
| | | 3. | dimethoate |
| | | 4. | ethoate-methyl |
| | | 5. | formothion |
| | | 6. | mecarbam |
| | | 7. | omethoate |
| | | 8. | prothoate |
| | | 9. | sophamide |
| | | 10. | vamidothion |
| | E. | oxime organothiophosphate insecticides | |
| | | 1. | chlorphoxim |
| | | 2. | phoxim |
| | | 3. | phoxim-methyl |
| | F. | heterocyclic organothiophosphate insecticides | |
| | | 1. | azamethiphos |
| | | 2. | coumaphos |
| | | 3. | coumithoate |
| | | 4. | dioxathion |
| | | 5. | endothion |
| | | 6. | menazon |
| | | 7. | morphothion |
| | | 8. | phosalone |
| | | 9. | pyraclofos |
| | | 10. | pyridaphenthion |
| | | 11. | quinothion |
| | G. | benzothiopyran organothiophosphate insecticides | |
| | | 1. | dithicrofos |
| | | 2. | thicrofos |
| | H. | benzotriazine organothiophosphate insecticides | |
| | | 1. | azinphos-ethyl |
| | | 2. | azinphos-methyl |
| | I. | isoindole organothiophosphate insecticides | |
| | | 1. | dialifos |
| | | 2. | phosmet |
| | J. | isoxazole organothiophosphate insecticides | |
| | | 1. | isoxathion |
| | | 2. | zolaprofos |
| | K. | pyrazolopyrimidine organothiophosphate insecticides | |
| | | 1. | chlorprazophos |
| | | 2. | pyrazophos |
| | L. | pyridine organothiophosphate insecticides | |
| | | 1. | chlorpyrifos |
| | | 2. | chlorpyrifos-methyl |
| | M. | pyrimidine organothiophosphate insecticides | |
| | | 1. | butathiofos |
| | | 2. | diazinon |
| | | 3. | etrimfos |
| | | 4. | lirimfos |
| | | 5. | pirimiphos-ethyl |
| | | 6. | pirimiphos-methyl |
| | | 7. | primidophos |
| | | 8. | pyrimitate |
| | | 9. | tebupirimfos |
| | N. | quinoxaline organothiophosphate insecticides | |
| | | 1. | quinalphos |
| | | 2. | quinalphos-methyl |
| | O. | thiadiazole organothiophosphate insecticides | |
| | | 1. | athidathion |
| | | 2. | lythidathion |
| | | 3. | methidathion |
| | | 4. | prothidathion |
| | P. | triazole organothiophosphate insecticides | |
| | | 1. | isazofos |
| | | 2. | triazophos |
| | Q. | phenyl organothiophosphate insecticides | |
| | | 1. | azothoate |
| | | 2. | bromophos |
| | | 3. | bromophos-ethyl |
| | | 4. | carbophenothion |
| | | 5. | chlorthiophos |
| | | 6. | cyanophos |
| | | 7. | cythioate |
| | | 8. | dicapthon |
| | | 9. | dichlofenthion |
| | | 10. | etaphos |
| | | 11. | famphur |
| | | 12. | fenchlorphos |
| | | 13. | fenitrothion |
| | | 14. | fensulfothion |
| | | 15. | fenthion |
| | | 16. | fenthion-ethyl |
| | | 17. | heterophos |
| | | 18. | jodfenphos |
| | | 19. | mesulfenfos |
| | | 20. | parathion |
| | | 21. | parathion-methyl |
| | | 22. | phenkapton |
| | | 23. | phosnichlor |
| | | 24. | profenofos |
| | | 25. | prothiofos |
| | | 26. | sulprofos |
| | | 27. | temephos |
| | | 28. | trichlormetaphos-3 |
| | | 29. | trifenofos |
| | R. | phosphonate insecticides | |
| | | 1. | butonate |
| | | 2. | trichlorfon |
| | S. | phosphonothioate insecticides | |
| | | 1. | mecarphon |
| | T. | phenyl ethylphosphonothioate insecticides | |
| | | 2. | fonofos |
| | | 3. | trichloronat |
| | U. | phenyl phenylphosphonothioate insecticides | |
| | | 1. | cyanofenphos |
| | | 2. | EPN |
| | | 3. | leptophos |
| | V. | phosphoramidate insecticides | |
| | | 1. | crufomate |
| | | 2. | fenamiphos |
| | | 3. | fosthietan |
| | | 4. | mephosfolan |
| | | 5. | phosfolan |
| | | 6. | pirimetaphos |
| | W. | phosphoramidothioate insecticides | |
| | | 1. | acephate |
| | | 2. | isofenphos |
| | | 3. | methamidophos |
| | | 4. | propetamphos |
| | X. | phosphorodiamide insecticides | |
| | | 1. | dimefox |
| | | 2. | mazidox |
| | | 3. | mipafox |
| IX. | Dinitrophenol insecticides | | |
| | A. | dinex | |
| | B. | dinoprop | |
| | C. | dinosam | |
| | D. | DNOC | |
| X. | Oxadiazine insecticides | | |
| | A. | indoxacarb | |
| XI. | Fluorine insecticides | | |
| | A. | barium hexafluorosilicate | |
| | B. | cryolite | |
| | C. | sodium fluoride | |
| | D. | sodium hexafluorosilicate | |
| | E. | sulfluramid | |
| XII. | Pyrazole insecticides | | |
| | A. | acetoprole | |
| | B. | ethiprole | |
| | C. | fipronil | |
| | D. | tebufenpyrad | |
| | E. | tolfenpyrad | |
| | F. | vaniliprole | |
| XIII. | Formamidine insecticides | | |
| | A. | amitraz | |
| | B. | chlordimeform | |
| | C. | formetanate | |
| | D. | formparanate | |
| XIV. | Pyrethroid insecticides | | |
| | A. | pyrethroid ester insecticides | |
| | | 1. | acrinathrin |
| | | 2. | allethrin |
| | | 3. | bioallethrin |
| | | 4. | barthrin |
| | | 5. | bifenthrin |
| | | 6. | bioethanomethrin |
| | | 7. | cyclethrin |
| | | 8. | cycloprothrin |
| | | 9. | cyfluthrin |
| | | 10. | beta-cyfluthrin |
| | | 11. | cyhalothrin |
| | | 12. | gamma-cyhalothrin |
| | | 13. | lambda-cyhalothrin |
| | | 14. | cypermethrin |
| | | 15. | alpha-cypermethrin |
| | | 16. | beta-cypermethrin |
| | | 17. | theta-cypermethrin |
| | | 18. | zeta-cypermethrin |
| | | 19. | cyphenothrin |
| | | 20. | deltamethrin |
| | | 21. | dimethrin |
| | | 22. | empenthrin |
| | | 23. | fenfluthrin |
| | | 24. | fenpirithrin |
| | | 25. | fenpropathrin |
| | | 26. | fenvalerate |
| | | 27. | esfenvalerate |
| | | 28. | flucythrinate |
| | | 29. | fluvalinate |
| | | 30. | tau-fluvalinate |
| | | 31. | furethrin |
| | | 32. | imiprothrin |
| | | 33. | permethrin |
| | | 34. | biopermethrin |
| | | 35. | transpermethrin |
| | | 36. | phenothrin |
| | | 37. | prallethrin |
| | | 38. | pyresmethrin |
| | | 39. | resmethrin |
| | | 40. | bioresmethrin |
| | | 41. | cismethrin |
| | | 42. | tefluthrin |
| | | 43. | terallethrin |
| | | 44. | tetramethrin |
| | | 45. | tralomethrin |
| | | 46. | transfluthrin |
| | B. | pyrethroid ether insecticides | |
| | | 1. | etofenprox |
| | | 2. | flufenprox |
| | | 3. | halfenprox |
| | | 4. | protrifenbute |
| | | 5. | silafluofen |
| XV. | Fumigant insecticides | | |
| | A. | acrylonitrile | |
| | B. | carbon disulfide | |
| | C. | carbon tetrachloride | |
| | D. | chloroform | |
| | E. | chloropicrin | |
| | F. | para-dichlorobenzene | |
| | G. | 1,2-dichloropropane | |
| | H. | ethyl formate | |
| | I. | ethylene dibromide | |
| | J. | ethylene dichloride | |
| | K. | ethylene oxide | |
| | L. | hydrogen cyanide | |
| | M. | methyl bromide | |
| | N. | methylchloroform | |
| | O. | methylene chloride | |
| | P. | naphthalene | |
| | Q. | phosphine | |
| | R. | sulfuryl fluoride | |
| | S. | tetrachloroethane | |
| XVI. | Pyrimidinamine insecticides | | |
| | | 1. | flufenerim |
| | | 2. | pyrimidifen |
| XVII. | Inorganic insecticides | | |
| | A. | borax | |
| | B. | calcium polysulfide | |
| | C. | mercurous chloride | |
| | D. | potassium thiocyanate | |
| | E. | sodium thiocyanate | |
| XVIII. | Tetronic acid insecticides | | |
| | A. | spiromesifen | |
| XIX. | Insect growth regulators | | |
| | A. | chitin synthesis inhibitors | |
| | | 1. | bistrifluron |
| | | 2. | buprofezin |
| | | 3. | chlorfluazuron |
| | | 4. | cyromazine |
| | | 5. | diflubenzuron |
| | | 6. | flucycloxuron |
| | | 7. | flufenoxuron |
| | | 8. | hexaflumuron |
| | | 9. | lufenuron |
| | | 10. | novaluron |
| | | 11. | noviflumuron |
| | | 12. | penfluron |
| | | 13. | teflubenzuron |
| | | 14. | triflumuron |
| | B. | juvenile hormone mimics | |
| | | 1. | epofenonane |
| | | 2. | fenoxycarb |
| | | 3. | hydroprene |
| | | 4. | kinoprene |
| | | 5. | methoprene |
| | | 6. | pyriproxyfen |
| | | 7. | triprene |
| | C. | juvenile hormones | |
| | | 1. | juvenile hormone I |
| | | 2. | juvenile hormone II |
| | | 3. | juvenile hormone III |
| | D. | moulting hormone agonists | |
| | | 1. | chromafenozide |
| | | 2. | halofenozide |
| | | 3. | methoxyfenozide |
| | | 4. | tebufenozide |
| | E. | moulting hormones | |
| | | 1. | α-ecdysone |
| | | 2. | ecdysterone |
| | F. | moulting inhibitors | |
| | | 3. | diofenolan |
| | G. | precocenes | |
| | | 1. | precocene I |
| | | 2. | precocene II |
| | | 3. | precocene III |

| | |
|---|---|
| H. | dicyclanil |

That which is claimed is:

1. An insecticidal compound comprising an insecticidal peptide or nucleic acid covalently conjugated to a polymer, said polymer selected from the group consisting of hydrophilic polymers, lipophilic polymers, and combinations thereof.

2. A compound according to claim 1, wherein said polymer comprises a polysaccharide.

3. A compound according to claim 1, wherein said polymer comprises a polymer selected from the group consisting of polyalkylene oxides, polyalkylene glycols, polyoxyethylated polyols, polyvinylpyrrolidone, polyacrylates, polyvinyl alcohols, polyurethane, and combinations thereof.

4. A compound according to claim 1, wherein said polymer has a molecular weight of from 100 to 200,000 kilodaltons.

5. A compound according to claim 1, wherein said polymer and said peptide are included in said compound in a molar ratio of from 20:1 to 1:20.

6. A compound according to claim 1, wherein said peptide is a juvenile hormone esters.

7. A compound according to claim 1, wherein said peptide is a Bacillus thuringiensis insecticidal protein.

8. A compound according to claim 1, wherein said peptide is a neurotoxin.

9. A compound according to claim 1, wherein said peptide is a hormone.

10. A compound according to claim 1, wherein said peptide comprises at least 20 amino acids.

11. A compound according to claim 1, wherein said peptide consists of from 2 to 20 amino acids.

12. A composition comprising a compound according to claim 1 in an agriculturally acceptable carrier.

13. A composition according to claim 11, wherein said carrier is an aqueous carrier.

14. A composition according to claim 11, wherein said carrier is a non-aqueous carrier.

15. A method of controlling an insect pest, comprising contacting to an insect pest a compound according to claim 1 in an amount effective to control said insect pest.

16. A method according to claim 15, wherein said peptide does not ordinarily cross the insect gut into the insect hemolymph in toxic form, and wherein said polymer facilitates the crossing of said peptide across the insect gut into the insect hemolymph in an amount sufficient to render said peptide toxic to said insect.

17. A method according to claim 15, wherein said insect pest is a plant pest.

18. A method according to claim 15, wherein said insect pest is a plant pest, and said contacting step is carried oult by applying said compound to a plant suspected of carrying said insect pest.

19. A method according to claim 15, wherein said pest is an insect selected from the group consisting of coleopterans, lepidopterans, and dipterans.

20. A method according to claim 15, wherein said insect pest is a moth.

21. A method according to claim 15, wherein said pest is an insect of the suborder Nematocera.

22. A method according to claim 15, wherein said pest is an insect of the family Colicidae.

23. A method according to claim 15, wherein said pest is an insect of a subfamily selected from the group consisting of Culicinae, Corethrinae, Ceratopogonidae and Simuliidae.

24. A method according to claim 15, wherein said pest is selected from the group consisting of flies, fleas, ticks, lice, aphids, and mosquitoes.

25. A method according to claim 15, wherein said pest is selected from the group consisting of beetles, caterpillars, and mites.

26. A method according to claim 15, wherein said pest is selected from the group consisting of ants and cockroaches.

27. A method of making the insecticidal compound of claim 1, comprising covalently conjugating an insecticidal peptide or nucleic acid to a polymer, to produce a covalent conjugate, said polymer selected from the group consisting of hydrophilic polymers, lipophilic polymers, and combinations thereof.

28. A method according to claim 27, wherein said polymer comprises a polysaccharide.

29. A method according to claim 27, wherein said polymer comprises a polymer selected from the group consisting of polyalkylene oxides, polyalkylene glycols, polyoxyethylated polyols, polyvinylpyrrolidone, polyacrylates, polyvinyl alcohols, polyurethane, and combinations thereof.

30. A method according to claim 27, wherein said polymer has a molecular weight of from 100 to 200,000 kilodaltons.

31. A method according to claim 27, wherein said polymer and said peptide are included in said compound in a molar ratio of from 20:1 to 1:20.

32. A method according to claim 27, wherein said peptide is a juvenile hormone esters.

33. A method according to claim 27, wherein said peptide is a Bacillus thuringiensis insecticidal protein.

34. A method according to claim 27, wherein said peptide is a neurotoxin.

35. A method according to claim 27, wherein said peptide is a hormone.

36. A method according to claim 27, wherein said peptide comprises at least 20 amino acids.

37. A method according to claim 27, wherein said peptide consists of from 2 to 20 amino acids.

38. An insecticidal compound comprising an insecticide covalently conjugated to a polymer, said polymer selected from the group consisting of hydrophilic polymers, lipophilic polymers, and combinations thereof.

39. A compound according to claim 38, wherein said polymer comprises a polysaccharide.

40. A compound according to claim 38, wherein said polymer comprises a polymer selected from the group consisting of polyalkylene oxides, polyalkylene glycols, polyoxyethylated polyols, polyvinylpyrrolidone, polyacrylates, polyvinyl alcohols, polyurethane, and combinations thereof.

41. A compound according to claim 38, wherein said polymer has a molecular weight of from 100 to 200,000 kilodaltons.

42. A compound according to claim 38, wherein said polymer and said insecticide are included in said compound in a molar ratio of from 20:1 to 1:20.

43. A compound according to claim 38, wherein said insecticide is spinosad.

44. A compound according to claim 38, wherein said insecticide is acetamiprid.

44. A compound according to claim 38, wherein said insecticide is fipronil.

45. A composition comprising a compound according to claim 38 in an agriculturally acceptable carrier.

46. A composition according to claim 45, wherein said carrier is an aqueous carrier.

47. A composition according to claim 45, wherein said carrier is a non-aqueous carrier.

48. A composition according to claim 38, wherein said insecticide is covalently conjugated to said polymer via a cleavable linkage.

49. A method of controlling an insect pest, comprising contacting to an insect pest a compound according to claim 38 in an amount effective to control said insect pest.

50. A method according to claim 49, wherein said peptide does not ordinarily cross the insect gut into the insect hemolymph in toxic form, and wherein said polymer facilitates the crossing of said peptide across the insect gut into the insect hemolymph in an amount sufficient to render said peptide toxic to said insect.

51. A method according to claim 49, wherein said insect pest is a plant pest.

52. A method according to claim 49, wherein said insect pest is a plant pest, and said contacting step is carried out by applying said compound to a plant suspected of carrying said insect pest.

53. A method according to claim 49, wherein said pest is an insect selected from the group consisting of coleopterans, lepidopterans, and dipterans.

54. A method according to claim 49, wherein said insect pest is a moth.

55. A method according to claim 49, wherein said pest is an insect of the suborder Nematocera.

56. A method according to claim 49, wherein said pest is an insect of the family Colicidae.

57. A method according to claim 49, wherein said pest is an insect of a subfamily selected from the group consisting of Culicinae, Corethrinae, Ceratopogonidae and Simuliidae.

58. A method according to claim 49, wherein said pest is selected from the group consisting of flies, fleas, ticks, lice, aphids, and mosquitoes.

59. A method according to claim 49, wherein said pest is selected from the group consisting of beetles, caterpillars, and mites.

60. A method according to claim 49, wherein said pest is selected from the group consisting of ants and cockroaches.

61. A method of making the insecticidal compound of claim 38, comprising covalently conjugating an insecticide to a polymer, to produce a covalent conjugate, said polymer selected from the group consisting of hydrophilic polymers, lipophilic polymers, and combinations thereof.

62. A method according to claim 61, wherein said polymer comprises a polysaccharide.

63. A method according to claim 61, wherein said polymer comprises a polymer selected from the group consisting of polyalkylene oxides, polyalkylene glycols, polyoxyethylated polyols, polyvinylpyrrolidone, polyacrylates, polyvinyl alcohols, polyurethane, and combinations thereof.

64. A method according to claim 61, wherein said polymer has a molecular weight of from 100 to 200,000 kilodaltons.

65. A method according to claim 61, wherein said polymer and said insecticide are included in said compound in a molar ratio of from 20:1 to 1:20.
